(19) United States
(12) Patent Application Publication
(10) Pub. No.: US 2015/0096304 A1
(43) Pub. Date: Apr. 9, 2015

(54) AIR ACCELERATOR ON TIE ROD WITHIN TURBINE DISK BORE

(71) Applicant: GENERAL ELECTRIC COMPANY, Schenectady, NY (US)

(72) Inventors: Robert Clayton von der Esch, Salem, MA (US); Jason Francis Pepi, North Andover, MA (US); Kevin Patrick Norcott, Waltham, MA (US)

(21) Appl. No.: 14/396,776

(22) PCT Filed: Apr. 26, 2013
(86) PCT No.: PCT/US13/38330

§ 371 Date: Oct. 24, 2014

Related U.S. Application Data
(60) Provisional application No. 61/639,429, filed on Apr. 27, 2012.

(51) Int. Cl. F01D 5/06; F02C 7/20

(52) U.S. Cl. CPC F01D 5/066; F02C 7/20
USPC 60/796

(57) ABSTRACT

A gas turbine engine high pressure rotor with first and second high pressure turbine stages include first and second stage disks having first and second stage disk bores and a single tie rod therethrough. First and second bore annular flowpaths are radially located between first and second stage disk bores and tie rod. A means for increased cooling and/or heating in second stage disk bore is axially located within second stage disk bore. The means may include an airflow accelerator such as one or more annular ribs on the tie rod. A bore annular cross-sectional flow area between the second stage disk hub and the ribs may be substantially smaller than between the second stage disk hub and the tie rod. An axially unobstructed inlet into the second bore annular flowpath allows fully axially flowing and axially unobstructed flowing of second stage bore cooling air into inlet.

### CROSS-REFERENCE TO RELATED APPLICATIONS

The present application claims priority to U.S. Provisional Patent Application Ser. No. 61/639,429, entitled “AIR ACCELERATOR ON TIE ROD WITHIN TURBINE DISK BORE”, filed Apr. 27, 2012, the disclosure of which is hereby incorporated by reference.

### BACKGROUND OF THE INVENTION

1. Field of the Invention

Embodiments of the present invention relate generally to thermal control of gas turbine engine turbine disks and, more specifically, controlling heat transfer rate at the turbine disk bore.

2. Description of Related Art

Several types of gas turbine engines include a high pressure rotor having an axial high pressure turbine (HPT) joined to a high pressure compressor (HPC) to form a high pressure rotor. The HPT typically includes one or more connected stages. Each stage includes a row of turbine blades or airfoils extending radially outwardly from an annular outer rim of a turbine disk. A disk web extends radially outwardly from a disk bore to the outer rim of the disk. A single tie bolt or tie rod through a high pressure bore of the high pressure rotor is tightened and secured by a lock-nut used to clamp together and place the high pressure rotor in compression. The disk bore is spaced apart from and circumscribes the tie rod. Such rotors are well known and an example of one is disclosed in U.S. Pat. No. 5,537,814, entitled “High pressure gas generator rotor tie rod system for gas turbine engine”, which issued Jul. 23, 1996, is assigned to the present assignee the General Electric Company, and which is incorporated herein by reference.

During engine acceleration, the outer rim of the second stage turbine disk heats up very rapidly as it is closest to the hot flowpath. The disk bore is much larger and does not heat up as quickly. This difference in temperature from the rim to the bore causes thermally induced stress in the second stage turbine disk. During engine deceleration, the outer rim of the second stage turbine disk cools down rapidly because the air flowing over the disk cools down. During this period, the disk bore remains at a much higher temperature until the entire turbine disk reaches thermal equilibrium. The disk bore is much larger and does not cool down or heat up as quickly as the disk rim. This difference in temperature from the rim to the bore causes thermally induced stress in the second stage turbine disk. Thermal control air is flowed through an annular passage between disk bore and the tie rod.

Thus, there continues to be a need to reduce thermally induced stresses in second stage turbine disks caused by differences in temperature and thermal conditions between the outer rim of the second stage turbine disk and the bore during engine acceleration and deceleration. There continues to be a need to reduce the thermal response time of second stage turbine disk bores relative to the outer rims of the second stage turbine disk during engine acceleration and deceleration.

### BRIEF DESCRIPTION OF THE INVENTION

A gas turbine engine high pressure rotor (12) includes first and second high pressure turbine stages (55, 56) with first and second stage disks (60, 62) having first and second stage disk hubs (154, 156) with first and second stage disk bores (164, 166) therethrough respectively. A single tie rod (170) disposed through the first and second stage disk bores (164, 166). First and second bore annular flowpaths (184, 186) are radially located between the first and second stage disk hubs (154, 156) and the tie rod (170) and a means for increased cooling and/or heating in the second stage disk bore (166) is axially located within the second stage disk bore (166). The first stage bore annular flowpath (184) may include a substantially constant first cross-sectional flow area (200) between the first stage disk hub (154) and the tie rod (170).

The means may include an airflow accelerator (188) axially located within the second stage disk bore (166) such as one or more annular ribs (190) on the tie rod (170). A bore annular cross-sectional flow area (200) between the second stage disk hub (156) and the ribs (190) may be substantially smaller than between the second stage disk hub (156) and the tie rod (170).

An axially unobstructed inlet (206) into the second bore annular flowpath (186) may be used for fully axially flowing and axially unobstructed flowing second stage bore cooling air (180) into the inlet (206). An axially unobstructed outlet (208) out of the second bore annular flowpath (186) may be used for fully axially flowing and axially unobstructed flowing of second stage bore cooling air (180) out of the outlet (208). A converging section (207) of the second bore annular flowpath (186) may be in the inlet (206) and converge in the inlet (206) to a forwardmost plateau (210) of a forwardmost one of the ribs (190). A diverging section (209) of the second bore annular flowpath (186) may be in the outlet (208) and diverge in the outlet (208) aftwardly from an aftwardmost plateau (210) of an aftwardmost one of the ribs (190).

One particular embodiment of the airflow accelerator (188) includes only two of the annular ribs (190) and the two annular ribs (190) being axially unevenly distributed along the tie rod (170) within the second stage disk bore (166). The two annular ribs (190) may be axially located in about a first or upstream half of a bore axial length (218) of the second stage disk bore (166).

### BRIEF DESCRIPTION OF THE DRAWINGS

FIG. 1 is a sectional view diagrammatical illustration of a gas turbine engine having an airflow accelerator on a tie rod within a second stage turbine disk bore.

FIG. 2 is an enlarged sectional view illustration of a combustor and high pressure turbine in a high pressure rotor illustrated in FIG. 1.

FIG. 3 is an enlarged sectional view illustration of the high pressure turbine illustrated in FIG. 2 with an airflow accelerator having annular ribs on a tie rod in the high pressure turbine.

FIG. 4 is an enlarged sectional view illustration of the airflow accelerator on the tie rod in the high pressure turbine illustrated in FIG. 3.

FIG. 5 is a perspective view illustration of the ribs on the tie rod in the high pressure turbine illustrated in FIG. 4.

FIG. 6 is an enlarged sectional view illustration of the airflow accelerator with axially longer ribs than the ribs illustrated in FIG. 4.

FIG. 7 is an enlarged sectional view illustration of the airflow accelerator with a single axially long rib on the tie rod in the high pressure turbine illustrated in FIG. 3.

FIG. 8 is an enlarged sectional view illustration of the airflow accelerator with two ribs on the tie rod in the high pressure turbine illustrated in FIG. 3.

### DETAILED DESCRIPTION OF THE INVENTION

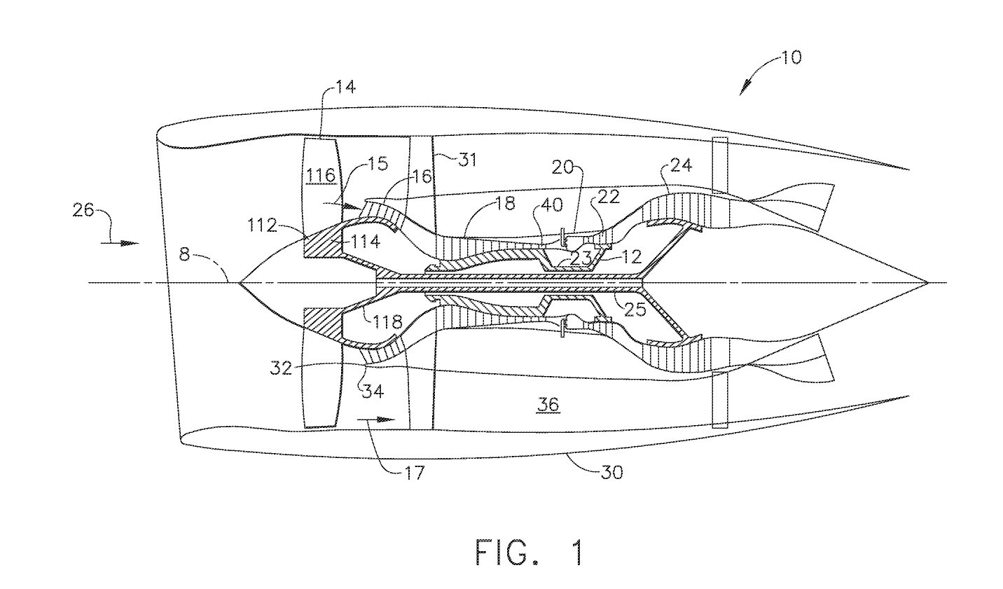

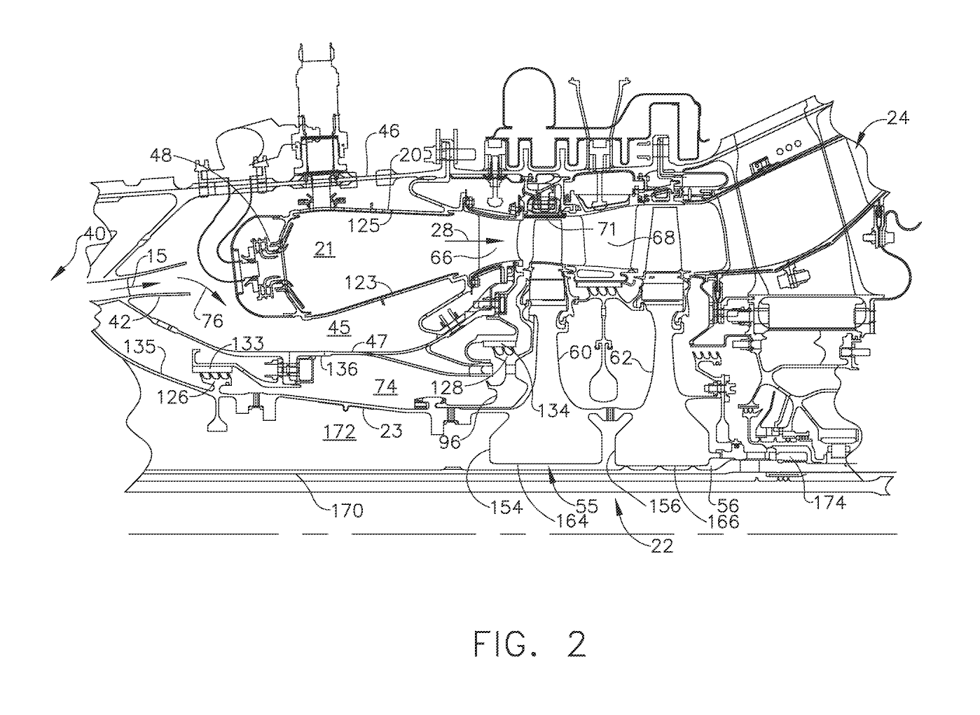

Illustrated in FIGS. 1 and 2 is an exemplary aircraft turbofan gas turbine engine 10 circumscribed about an engine centerline axis 8 and suitably designed to be mounted to a wing or fuselage of an aircraft. The engine 10 includes, in downstream serial flow communication, a fan 14, a low pressure compressor or booster 16, a high pressure compressor (HPC) 18, a combustor 20, a high pressure turbine (HPT) 22, and a low pressure turbine (LPT) 24. The HPT or high pressure turbine 22 is joined by a high pressure drive shaft 23 to the high pressure compressor 18 in what is referred to as a high pressure rotor 12. The LPT or low pressure turbine 24 is joined by a low pressure drive shaft 25 to both the fan 14 and the booster 16. The fan 14 includes a fan rotor 112 having a plurality of circumferentially spaced apart fan blades 116 which extend radially outwardly from a fan disk 114. The fan disk 114 and the low pressure compressor or booster 16 are connected to a fan shaft 118 that is connected to the low pressure drive shaft 25 and is powered by the LPT 24.

Referring to FIG. 1, in typical operation, air 26 is pressurized by the fan 14. A flow splitter 34 surrounding the booster 16 immediately behind the fan 14 includes a sharp leading edge 32 which splits the fan air 26 pressurized by the fan 14 into a radially inner air flow 15 channeled through the booster 16 and a radially outer air flow 17 channeled through a bypass duct 36. The inner air flow 15 is further pressurized by the booster 16. A fan casing 30 surrounding the fan 14 is supported by an annular fan frame 31. The pressurized air is then flowed to the high pressure compressor 18 which further pressurizes the air. The high pressure compressor 18 illustrated herein includes a final high pressure stage 40 which produces what is referred to as compressor discharge pressure (CDP) air 76 which exits the high pressure compressor 18 and passes through a diffuser 42 and into the combustion chamber 45 within the combustor 20 as illustrated in FIG. 2.

Referring to FIG. 2, the compressor discharge pressure (CDP) air 76 flows into a combustion chamber 45 surrounded by annular radially outer and inner combustor casings 46, 47. The combustion chamber 45 includes annular radially outer and inner combustion liners 123, 125 surrounding a combustion zone 21. The pressurized air is mixed with fuel provided by a plurality of fuel nozzles 48 and the mixture ignited in the combustion zone 21 of the combustor 20 to generate hot combustion gases 28 that flow downstream through the HPT 22 and the LPT 24. The combustion produces hot combustion gases 28 flow through the high pressure turbine 22 causing rotation of the high pressure rotor 12 and then continue downstream for further work extraction in the low pressure turbine 24.

In the exemplary embodiment of the engine depicted herein, the high pressure turbine 22 includes, in downstream serial flow relationship, first and second high pressure turbine stages 55, 56 having first and second stage disks 60, 62. A first stage nozzle 66 is directly upstream of the first high pressure turbine stage 55 and a second stage nozzle 68 is directly upstream of the second high pressure turbine stage 56. The compressor discharge pressure (CDP) air 76 discharged from the diffuser 42 is used for combustion and to cool components of turbine subjected to the hot combustion gases 28.

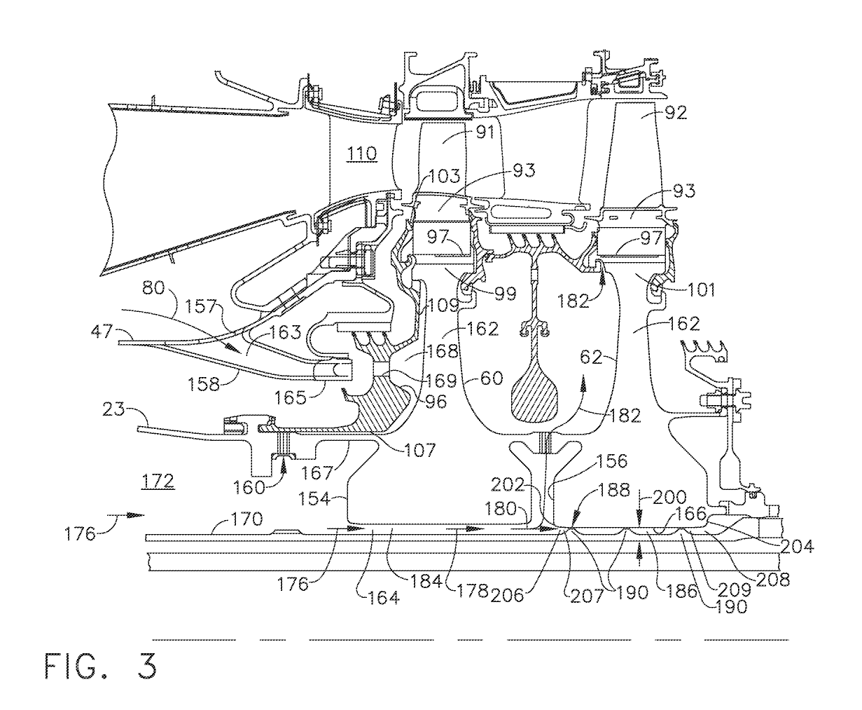

Referring to FIGS. 2 and 3, components of turbine cooled by the CDP air 76 include the first stage nozzle 66, a first stage shroud 71 and the first stage disk 60. An annular cavity 74 is radially disposed between the inner combustor casing 47 and the high pressure drive shaft 23 of the high pressure rotor 12. The annular cavity 74 is axially sealed by forward and aft thrust balance seals 126, 128. The forward thrust balance seal 126 is located on a radially outer surface 135 of the high pressure drive shaft 23 between the high pressure compressor 18 and the high pressure turbine 22. The forward thrust balance seal 126 seals against a forward thrust balance land 133 mounted on a radially inner surface 136 of the inner combustor casing 47. The aft thrust balance seal 128 is located on a boltless blade retainer 96 and seals against an aft thrust balance land 134 mounted on the inner combustor casing 47.

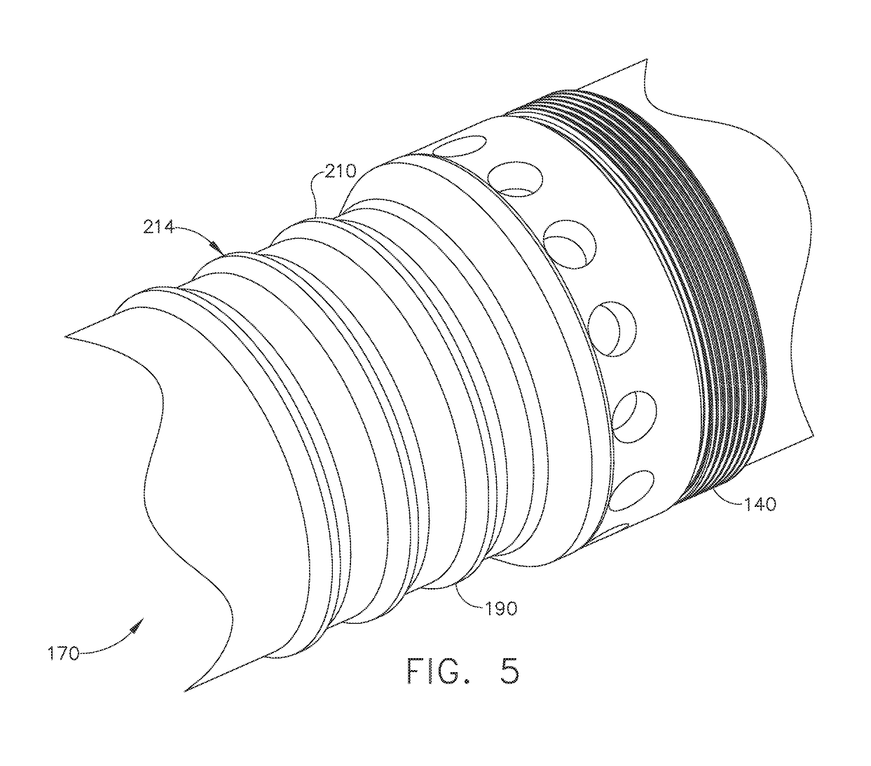

Referring to FIG. 3, high pressure turbine first and second stage blades 91, 92 are mounted by blade roots 93 in axially extending blade root slots 97 in first and second outer rims 99, 101 of the first and second stage disks 60, 62 respectively. Disk webs 162 extends radially outwardly from first and second stage disk hubs 154, 156 to the first and second outer rims 99, 101 of the first and second stage disks 60, 62 respectively. A forward extending annular disk arm 167 of the first stage disk hub 154 is connected to the high pressure drive shaft 23 with a curvic coupling 160. First and second stage disk hubs 154, 156 include first and second stage disk bores 164, 166 extending therethrough. A single tie bolt or tie rod 170 is disposed through a rotor bore 172 of the high pressure rotor 12 (illustrated in FIG. 2) including through the first and second stage disk bores 164, 166. A lock-nut 174 threaded on threads 140 (illustrated in FIG. 5) on the tie rod 170 is used to tighten, secure, and clamp together and place the high pressure rotor 12 in compression. The boltless blade retainer 96 axially retains the blade roots 93 in the blade root slots 97 of the first stage disk 60. The boltless blade retainer 96 is secured to the outer rim 101 of the first stage disk 60 by a bayonet connection 103. The blade retainer 96 includes a retainer bore 107 positioned radially inwardly of and connected by a retainer plate 109 to the bayonet connection 103. The first and second stage blades 91, 92 extend radially outwardly across a hot flowpath 110 of the high pressure turbine (HPT) 22.

Cooling air apertures 157 in the inner combustor casing 47 allows turbine blade cooling air 80 from the compressor discharge pressure air 76 to flow into an annular cooling air plenum 163 within a plenum casing 158. The blade cooling air 80 is accelerated by a one or more accelerators 165 attached to the plenum casing 158 at an aft end of the cooling air plenum 163. The accelerators 165 inject the blade cooling air 80 into a stage one disk forward cavity 168 through cooling holes 169 in the retainer plate 109. The stage one disk forward cavity 168 is positioned axially between the retainer plate 109 and the disk web 162 of the first stage disk 60. The accelerators 165 inject the blade cooling air 80 at a high tangential speed approaching wheel speed of the first stage disk 60 at a radial position of the accelerator 165. The blade cooling air 80 then flows through the stage one disk forward cavity 168 and cools the first stage disk 60 and the first stage blades 91.

During engine acceleration, the outer rims 101 of the first and second stage disks 60, 62 tend to heat up very rapidly as they are closest to the hot flowpath 110. The cooling air 80 cools the first stage disk 60, the first outer rim 99 and the first stage blades 91 mounted thereupon. Rotor bore cooling air 176 from the rotor bore 172 provides first and second stage bore cooling air 178, 180, and second stage blade cooling air 182. Because rotor bore cooling air 176 is used to cool the first stage disk hub 154 and the second stage blades 92 before cooling the second stage disk hub 156, the rate of thermal response during engine transients such as acceleration and deceleration is faster for the first stage disk hub 154 than for the second stage disk hub 156. The second stage disk hub 156 is much larger and more massive than the second outer rim 101 of the second stage disk 62 and does not heat up or cool down as quickly. This difference in temperature from the rim to the bore causes thermally induced stress in the turbine second stage disk 62 not experienced to the same degree in the first stage disk hub 154. Note that the first and second stage bore cooling air 178, 180 is used to both cool and heat the first and second stage disk hubs 154, 156 respectively.

Referring to FIG. 3, cooling of the first and second stage disk hubs 154, 156 is provided by first and second bore annular flowpaths 184, 186 radially located between the first and second stage disk hubs 154, 156 within the first and second stage disk bores 164, 166 of the first and second stage disks 60, 62 and the tie bolt or tie rod 170. To alleviate thermal stress in the second stage disk 62, the second stage disk hub 156 is cooled or heated faster by an airflow accelerator 188 axially located within the second stage disk bore 166. The airflow accelerator 188 increases the velocity of the second stage bore cooling air 180 in the second bore annular flowpath 186 within the second stage disk bore 166. The airflow accelerator 188 illustrated herein includes one or more ribs 190 with corresponding one or more plateaus 210.

The exemplary airflow accelerator 188 illustrated in FIGS. 2-6 includes three annular ribs 190 on the tie rod 170 and the exemplary airflow accelerator 188 illustrated in FIG. 7 includes a single rib 190 on the tie rod 170. The ribs are also referred to as lands. This reduces a bore annular cross-sectional flow area 200 between the second stage disk hub 156 and the plateaus 210 of the ribs 190 on the tie rod 170. This causes the velocity of the flow to increase under the disk which causes a better heat transfer coefficient and an increased rate of heat transfer to the second stage disk hub 156. The bore annular cross-sectional flow area 200 between second stage disk hub 156 and ribs 190 is substantially smaller than the bore annular cross-sectional flow area 200 between second stage disk hub 156 and tie rod 170. The multi rib embodiments of the airflow accelerator 188 are not limited to 3 ribs, thus, the airflow accelerator 188 may have one or more ribs.

The ribs 190 are axially located well within the second stage disk bore 166 between bore leading and trailing edges 202, 204 of the second stage disk bore 166. This provides an axially unobstructed inlet 206 and an axially unobstructed outlet 208 to and from the second bore annular flowpath 186 respectively within the second stage disk bore 166. The second bore annular flowpath 186 includes a converging section 207 in the inlet 206 that converges in the inlet 206 until it reaches a plateau 210 of a forwardmost one of the rib 190. The second bore annular flowpath 186 includes a diverging section 209 in the outlet 208 that diverges in the outlet 208 from a plateau 210 of the aftwardmost of the ribs 190. The axially unobstructed inlet and outlet 206, 208 provides a fully axial and axially unobstructed flow of the second stage bore cooling air 180 into the inlet 206 and out of the outlet 208 which helps bore heating and cooling. A bore inner surface area 212 and a plateau surface area 214 are cylindrical concentric with respect to each other. The cross-sectional flow area 200 between the second stage disk hub 156 and the tie rod 170 (where there is no rib 190) is less than the cross-sectional flow area 200 between the first stage disk hub 154 and the tie rod 170. The cross-sectional flow area 200 between the first stage disk hub 154 and the tie rod 170 which has no ribs 190 is substantially constant.

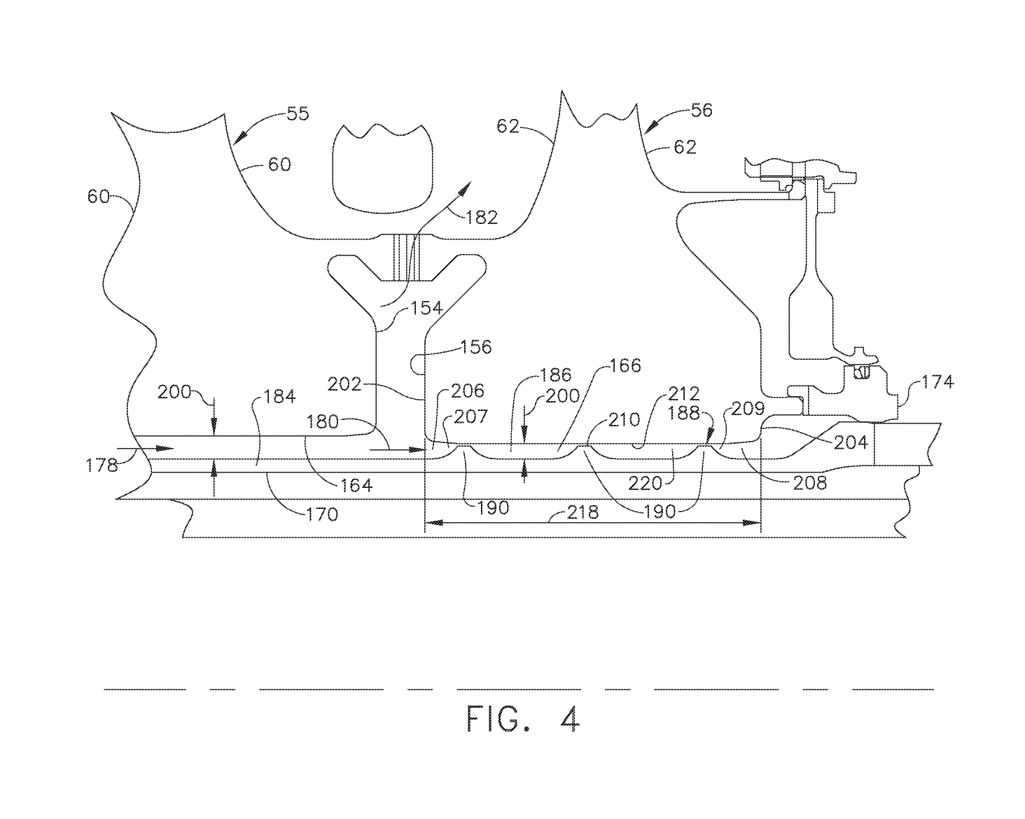

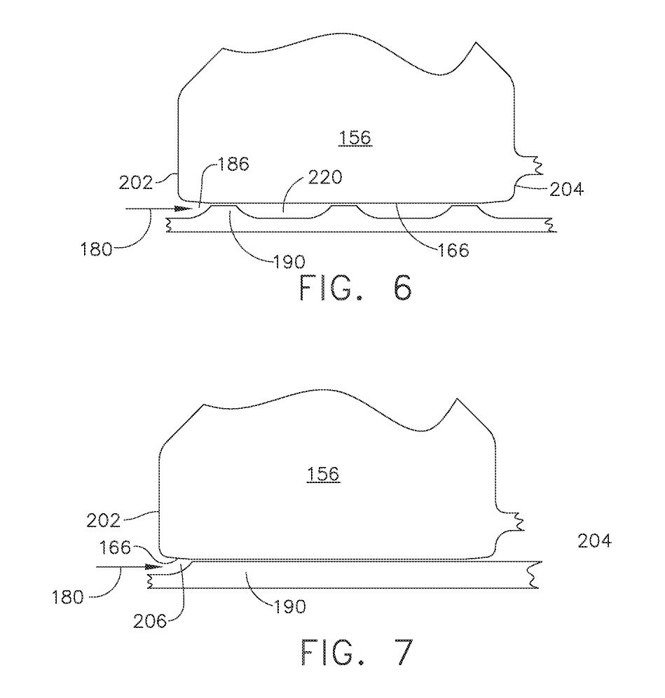

FIG. 6 illustrates an airflow accelerator 188 with three annular ribs 190 on the tie rod 170 and plateaus 210 that are axially longer than the three rib embodiment illustrated in FIGS. 3 and 4. The number of ribs and plateau axial lengths 218 of the ribs 190 take into consideration weight added by the ribs and a desire to keep air cavities 220 between ribs 190 to a minimum because larger air cavities 220 tend to slow down the second stage bore cooling air 180.

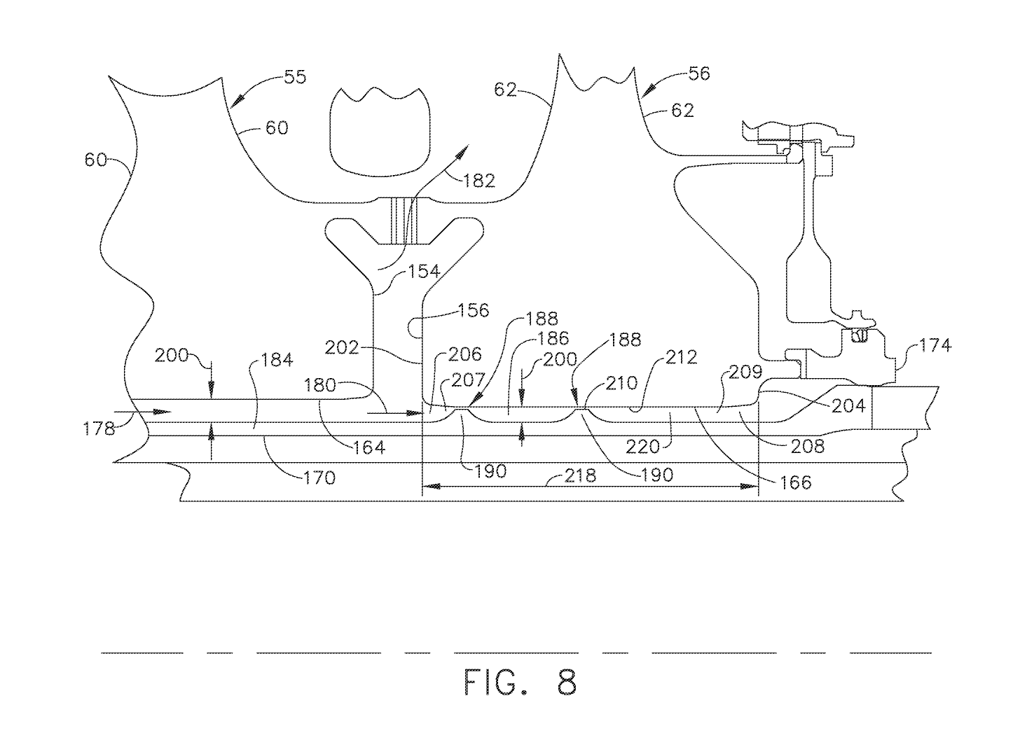

FIG. 8 illustrates a two rib embodiment of the airflow accelerator 188 having two annular ribs 190 on the tie rod 170. Note, that two annular ribs 190 in the two rib embodiment are illustrated as being axially unevenly distributed along the tie rod 170 within the second stage disk bore 166. The two annular ribs 190 are located in about the first or upstream half of a bore axial length 218 of the second stage disk bore 166 between the bore leading and trailing edges 202, 204 of the second stage disk bore 166.

FIG. 7 illustrates a single rib 190 on the tie rod 170 axially located well within the second stage disk bore 166 between the bore leading and trailing edges 202, 204 of the second stage disk bore 166. It also has an unobstructed inlet 206 and an unobstructed outlet 208 to and from the second bore annular flowpath 186 respectively within the second stage disk bore 166.

During engine acceleration, the outer rim 101 of the second stage disk 62 heats up very rapidly as it is closest to the hot flowpath 110 of the high pressure turbine (HPT) 22. The second stage disk hub 156 of the second stage disk 62 is much larger and does not heat up as quickly. This difference in temperature from the rim to the hub causes thermal stress in the disk. The airflow accelerator 188 alleviates this thermal stress by heating up the second stage disk hub 156 faster by reducing the cross-sectional flow area 200 between the second stage disk hub 156 and the one or more ribs 190 on the tie rod 170. This causes the velocity of the second stage bore cooling air 180 in the second bore annular flowpath 186 to increase under the disk which causes a better heat transfer coefficient and an increased rate of heat transfer to the disk hub.

During engine deceleration, the outer rim 101 of the second stage disk 62 cools down rapidly and the second stage disk hub 156 of the second stage disk 62 remains at it's increased temperature. This difference in temperature from the rim to the hub causes thermal stress in the disk in the opposite direction to thermal stress caused by engine acceleration. During engine deceleration, the second stage bore cooling air 180 cools down from level before the engine deceleration. The airflow accelerator 188 alleviates this thermal stress by cooling down the second stage disk hub 156 faster by reducing the cross-sectional flow area 200 between the second stage disk hub 156 and the one or more ribs 190 on the tie rod 170. This causes the velocity of the second stage bore cooling air 180 to increase under the second stage disk hub 156 producing a better heat transfer coefficient and an increased rate of heat transfer from the disk hub to the second stage bore cooling air 180.

While there have been described herein what are considered to be preferred and exemplary embodiments of the present invention, other modifications of the invention shall be apparent to those skilled in the art from the teachings herein and, it is therefore, desired to be secured in the appended claims all such modifications as fall within the true spirit and scope of the invention. Accordingly, what is desired to be secured by Letters Patent of the United States is the invention as defined and differentiated in the following claims.

What is claimed is:

1. A gas turbine engine high pressure rotor comprising:
first and second high pressure turbine stages comprising first and second stage disks comprising first and second stage disk hubs respectively;
a single tie rod disposed through first and second stage disk bores through the first and second stage disk hubs respectively;
first and second bore annular flowpaths radially located between the first and second stage disk hubs respectively and the tie rod; and
a mechanism configured to increase cooling and/or heating of the second stage disk hub within the second stage disk bore.

2. The rotor as claimed in claim 1, wherein the mechanism comprises an airflow accelerator axially located within the second stage disk bore.

3. The rotor as claimed in claim 2, wherein the airflow accelerator comprises one or more annular ribs on the tie rod.

4. The rotor as claimed in claim 3, wherein a bore annular cross-sectional flow area between the second stage disk hub and plateaus of the ribs is substantially smaller than between the second stage disk hub and the tie rod.

5. The rotor as claimed in claim 4, further comprising an axially unobstructed inlet into the second bore annular flowpath for fully axially flowing and axially unobstructed flowing of second stage bore cooling air into the axially unobstructed inlet.

6. The rotor as claimed in claim 5, further comprising an axially unobstructed outlet out of the second bore annular flowpath for fully axially flowing and axially unobstructed flowing of the second stage bore cooling air out of the outlet.

7. The rotor as claimed in claim 5, further comprising a converging section of the second bore annular flowpath in the inlet, the converging section converging in the inlet to a forwardmost one of the plateaus of a forwardmost one of the ribs.

8. The rotor as claimed in claim 6, further comprising:
a converging section of the second bore annular flowpath in the inlet, the converging section converging in the inlet to a forwardmost one of the plateaus of a forwardmost one of the ribs;
a diverging section of the second bore annular flowpath in the outlet; and
the diverging section diverging in the outlet aftwardly from an aftwardmost plateau of an aftwardmost one of the ribs.

9. The rotor as claimed in claim 3, further comprising only two of the annular ribs and corresponding two of the plateaus.

10. The rotor as claimed in claim 9, wherein the two annular ribs are axially unevenly distributed along the tie rod within the second stage disk bore.

11. The rotor as claimed in claim 9, wherein the two annular ribs are axially located in about a first or an upstream half of a bore axial length of the second stage disk bore.

12. The rotor as claimed in claim 1, wherein the mechanism comprises an airflow accelerator axially located within the second stage disk bore, and a substantially constant first cross-sectional flow area between the first stage disk hub and the tie rod.

13. The rotor as claimed in claim 12, wherein the airflow accelerator comprises one or more annular ribs on the tie rod.

14. The rotor as claimed in claim 13, wherein a second bore annular cross-sectional flow area between the second stage disk hub and plateaus of the ribs is substantially smaller than between the second stage disk hub and the tie rod.

15. The rotor as claimed in claim 14, further comprising an axially unobstructed inlet into the second bore annular flowpath for fully axially flowing and axially unobstructed flowing of second stage bore cooling air into the axially unobstructed inlet.

16. The rotor as claimed in claim 15, further comprising an axially unobstructed outlet out of the second bore annular flowpath for fully axially flowing and axially unobstructed flowing of the second stage bore cooling air out of the outlet.

17. The rotor as claimed in claim 15, further comprising a converging section of the second bore annular flowpath in the inlet, the converging section converging in the inlet to a forwardmost one of the plateaus of a forwardmost one of the ribs.

18. The rotor as claimed in claim 16 further comprising:
a converging section of the second bore annular flowpath in the inlet, the converging section converging in the inlet to a forwardmost one of the plateaus of a forwardmost one of the ribs; and
a diverging section of the second bore annular flowpath in the outlet, wherein the diverging section diverges in the outlet aftwardly from an aftwardmost plateau of an aftwardmost one of the ribs.

19. The rotor as claimed in claim 13, further comprising only two of the annular ribs and corresponding two of the plateaus, wherein the two annular ribs are axially unevenly distributed along the tie rod within the second stage disk bore.

20. (canceled)

21. A gas turbine engine high pressure rotor, comprising:
a high pressure turbine joined by a high pressure drive shaft to a high pressure compressor, the high pressure turbine comprising first and second high pressure turbine stages comprising first and second stage disks comprising first and second stage disk hubs respectively;
a single tie rod disposed through first and second stage disk bores through the first and second stage disk hubs respectively;
first and second bore annular flowpaths radially located between the first and second stage disk hubs respectively and the tie rod; and
a mechanism configured to increase cooling and/or heating of the second stage disk hub within the second stage disk bore.

22.-41. (canceled)
